(19) United States
(12) Patent Application Publication
(10) Pub. No.: US 2011/0310859 A1
(43) Pub. Date: Dec. 22, 2011

(54) BASIC SERVICE SET SCHEDULING BASED ON MEDIA ACCESS CONTROLLER STATES

(75) Inventors: Ramanuja VEDANTHAM, Allen, TX (US); John W. THOMAS, Arlington, TX (US)

(73) Assignee: TEXAS INSTRUMENTS INCORPORATED, Dallas, TX (US)

(21) Appl. No.: 13/166,326

(22) Filed: Jun. 22, 2011

Related U.S. Application Data
(60) Provisional application No. 61/357,339, filed on Jun. 22, 2010.

(51) Int. Cl. H04W 72/04; H04J 3/00

(52) U.S. Cl. 370/336; 370/329

(57) ABSTRACT

Apparatus and methods for controlling a wireless device concurrently operating in more than one basic service set (BSS). In one embodiment, a wireless device includes a first medium access controller (MAC), a second MAC, and a BSS scheduler. The first MAC is configured to communicate in a first BSS via a first wireless network. The second MAC is configured to communicate in a second BSS via a second wireless network. The BSS scheduler is configured to time multiplex medium access by the first and second MACs. Each of the first and second MACs is configured to provide a response to the BSS scheduler and to relinquish medium access when a request to relinquish medium access is received by the MAC, the timing of the response and relinquishment based on an activity state of the MAC when the request is received.

### CROSS-REFERENCE TO RELATED APPLICATION

The present application claims priority to U.S. Provisional Patent Application No. 61/357,339, filed on Jun. 22, 2010 (Attorney Docket No. TI-69571); which is hereby incorporated herein by reference in its entirety.

### BACKGROUND

The number of available consumer and mobile wireless devices based on the IEEE 802.11 wireless networking standards (i.e., WI-FI CERTIFIED devices) is increasing rapidly. Increasing adoption of IEEE 802.11 wireless networking standards in devices beyond personal computers and Access Points enables new usage models. For example, a user may desire to use his mobile handset to share, show, print, and/or synchronize content by connecting with other consumer electronics or a mobile handset of another user through IEEE 802.11 based technologies, regardless of infrastructure network availability.

To satisfy this need, peer-to-peer networking standards that employ IEEE 802.11 based networking are being developed. The WI-FI DIRECT standard promulgated by the WI-FI ALLIANCE is one such standard that allows consumer electronics, mobile handsets, etc. to connect and communicate in an ad-hoc and peer-to-peer fashion.

### SUMMARY

Apparatus and methods for controlling a wireless device concurrently operating in more than one basic service set (BSS). In one embodiment, a wireless device includes a first medium access controller (MAC), a second MAC, and a BSS scheduler. The first MAC is configured to communicate in a first BSS via a first wireless network. The second MAC is configured to communicate in a second BSS via a second wireless network. The BSS scheduler is configured to time multiplex medium access by the first and second MACs. Each of the first and second MACs is configured to provide a response to the BSS scheduler and to relinquish medium access when a request to relinquish medium access is received by the MAC, the timing of the response and relinquishment based on an activity state of the MAC when the request is received.

In another embodiment, a method for dual basic service set control in a wireless device includes issuing to an active MAC of the wireless device, by a BSS scheduler of the wireless device, a request for the active MAC to relinquish medium access. The active MAC provides, to the BSS scheduler, a response to the request. The timing of the response is based on an activity state of the active MAC when the request is received. The active MAC relinquishes medium access in conjunction with the providing of the response.

In yet another embodiment, a MAC includes a MAC activity state indicator and a dual BSS scheduler interface. The MAC activity state indicator indicating an activity state of the MAC. The dual BSS scheduler interface is configured to receive a request from a BSS scheduler indicating that the MAC is to transition from an active BSS state to an inactive BSS state. The dual BSS scheduler interface is also configured to provide, to the dual BSS scheduler, a response to the request. The timing of the response is based on the activity state of the MAC when the request is received. The dual BSS scheduler interface is further configured to transition the MAC from the active BSS state to the inactive BSS state in conjunction with provision of the response.

### BRIEF DESCRIPTION OF THE DRAWINGS

For a detailed description of exemplary embodiments of the invention, reference will now be made to the accompanying drawings in which:

FIG. 1 shows a dual basic service set (BSS) wireless device concurrently operating in two IEEE 802.11 based wireless networks in accordance with various embodiments;

FIG. 2 shows a block diagram of a dual BSS wireless device in accordance with various embodiments;

FIG. 3 shows exemplary message flow between a BSS scheduler, an active BSS medium access controller (MAC), and an inactive BSS MAC in a dual BSS wireless device in accordance with various embodiments;

FIG. 4 shows an exemplary view of MAC states in a dual BSS wireless device in accordance with various embodiments;

FIG. 5 shows a flow diagram for a method for responding to a dual BSS request message based on MAC state in accordance with various embodiments; and

FIG. 6 shows a flow diagram for a method for changing BSS activation states in a dual BSS wireless device in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

One technique for providing peer-to-peer networking between IEEE 802.11 compliant devices involves configuring a consumer or mobile device, e.g., via software, to operate as an access point. Such a device serves a group master providing functionality analogous to that of an access point in an infrastructure network. Other devices connect with the group master in the same way that the devices would connect to a conventional access point.

Because a device can operate as a group master in a peer-to-peer network and a wireless station in an infrastructure network, the device can concurrently operate and maintain connections in two distinct IEEE 802.11 based wireless networks. Each network connection of the device is referred to herein as a Basic Service Set (BSS). Accordingly, a device that maintains connections to two IEEE 802.11 based wireless networks, as described above, is a part of two BSSs and operates in dual BSS mode. As used herein, “dual BSS mode” refers to an operational state wherein a device is concurrently connected to more than one BSS. A device operating in dual BSS mode should efficiently manage when each BSS will access the wireless resources shared by the BSSs. Embodiments of the present disclosure employ time multiplexing, and medium access controller (MAC) state information to efficiently share the wireless resources.

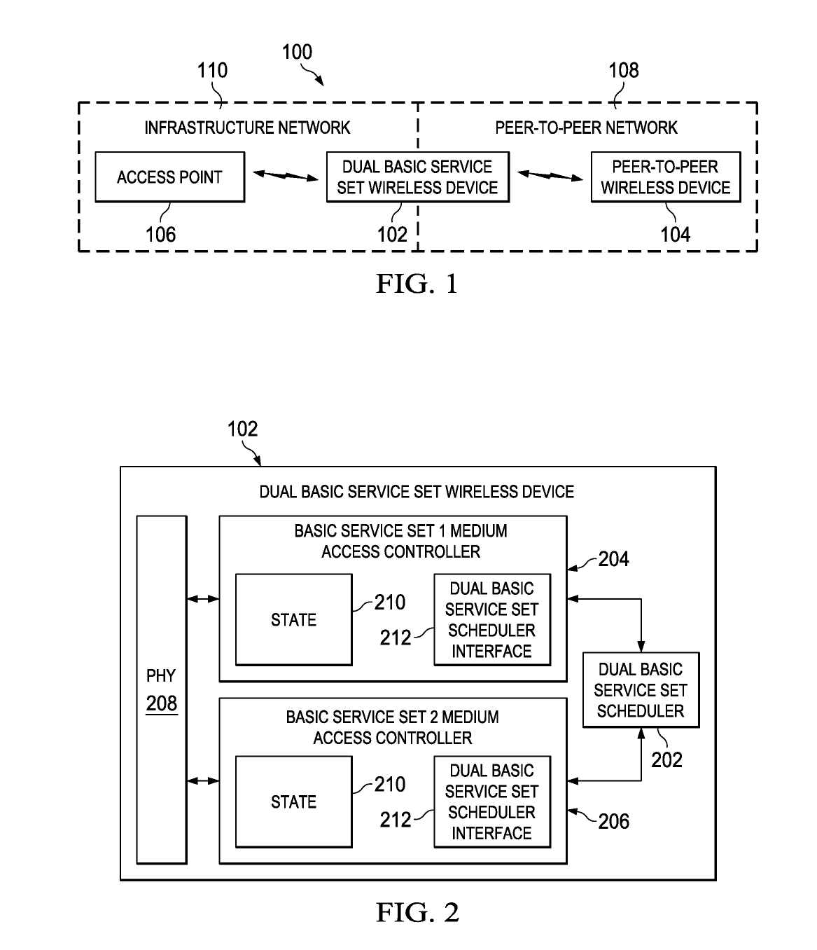

FIG. 1 shows a dual BSS wireless device 102 concurrently operating in two IEEE 802.11 based wireless networks in accordance with various embodiments. The wireless network 108 is a peer-to-peer network, e.g., a network compliant with the Wi-Fi Peer-to-Peer Specification promulgated by the WI-FI ALLIANCE. The dual BSS wireless device 102 communicates with the wireless device 104 using peer-to-peer protocols applicable to the wireless network 108. The dual BSS wireless device 102 may be the group master for the network 108, or alternatively, the wireless device 104 may be the group master for the network 108 and the dual BSS wireless device 102 may be a station connected to the group master.

The wireless network 110 may be an infrastructure based wireless network or a second peer-to-peer network. An infrastructure network is a network through which wireless stations access the network via a dedicated access point. Accordingly, the infrastructure network 110 includes an access point 106 and the dual BSS wireless device 102 operates as a wireless station connected to the access point 106. In peer-to-peer networks, devices communicate directly with one another, rather than through a dedicated access point. Consequently, if the wireless network 110 is a peer-to-peer network, then the dedicated access point 106 is replaced by a peer-to-peer (P2P) wireless device configured to employ peer-to-peer protocols (e.g., an instance of the wireless device 104), and one of the dual BSS wireless device 102 and the P2P wireless device functions as the group master while the other device functions as a station connected to the group master.

The dual BSS wireless device 102 is configured to share wireless resources (e.g., PHY hardware, MAC hardware, communication medium access, etc.) across the networks 108, 110. Sharing is implemented using time multiplexing (i.e., time division multiple access, TDMA) in some embodiments of the dual BSS wireless device 102, wherein access to the wireless resources and communication medium alternates between the BSSs. A dual BSS time multiplexing algorithm executed by the dual BSS wireless device 102 will determine the length time allocated to each BSS (i.e., BSS service time) and base this determination on a number of different factors. Some of these factors include the quality of service (QoS) requirements of each packet flow, packet traffic load, packet type, current data rates in use for each packet flow, power management status of the device 102, and a number of other characteristics of each flow and/or device within a BSS. A BSS enabled to access wireless resources is termed an “active BSS,” while a BSS not enabled to access wireless resources is termed an “inactive BSS.”

FIG. 2 shows a block diagram of the dual BSS wireless device 102 in accordance with various embodiments. The dual BSS wireless device 102 includes a dual BSS scheduler 202, a BSS 1 MAC 204, a BSS 2 MAC 206, and a PHY 208. The dual BSS scheduler 202 manages MACs 204, 206 access to the medium and other shared resources by sequentially activating and deactivating the MACs 204, 206. Each of the MACs 204, 206 perform the link layer operations required by the BSS to which the MAC is connected. For example, the BSS 1 MAC 204 may perform link layer operations for the BSS of the peer-to-peer network 108, and the BSS 2 MAC 206 may perform link layer operations for the BSS of the infrastructure network 110. In some embodiments of the wireless device 102, the MACs 204, 206 represent logical MACs that are connected to the respective BSSs while sharing access to physical MAC hardware resources. In such embodiments, the shared MAC hardware resource may be reconfigured to service the active BSS when the BSS is activated. The PHY 208 provides the electrical and physical interfaces between the device 102 and the wireless medium. In some embodiments, the PHY 208 and associated antennas are shared by the MACs 204, 206. Some embodiments of the dual BSS wireless device 102 may include more than one PHY 208. For example, each of the MACs 204, 206 may be coupled to a different PHY 208.

Each of the MACs 204, 206 include state storage 210 and a dual BSS scheduler interface 212. The state storage 210 stores the current state of the MAC for use in BSS state scheduling as explained below. The dual BSS state scheduler interface 212 interfaces with the dual BSS scheduler 202, and executes BSS state transition based on messages exchanged with the dual BSS scheduler 202 as described below.

The dual BSS scheduler 202 and the MACs 204, 206 communicate to implement a dual BSS control algorithm. The messages transferred between the dual BSS scheduler 202 and the MACs 204, 206 include a Dual BSS Request Message, a Dual BSS Response Message, and a Dual BSS Command Message. The Dual BSS Request Message is issued by the dual BSS scheduler 202 to a MAC 204, 206 requesting that the MAC transition from an active BSS state to an inactive BSS state. That is, the Dual BSS Request Message requests that the receiving MAC 204, 206 relinquish access to the wireless medium and other shared resources. In various embodiments of the wireless device 102, the Dual BSS Request Message is non-preemptive, indicating that a MAC 204, 206 receiving the message need not immediately transition to the inactive BSS state, but rather may transition to the inactive BSS state based on the state of the MAC 204, 206 when the message is received.

In reply to a received Dual BSS Request Message, a MAC 204, 206 issues a Dual BSS Response Message. The Dual BSS Response Message indicates to the dual BSS scheduler 202 that the MAC 204, 206 issuing the message has or will within a predetermined interval transition from active BSS state to inactive BSS state, thereby freeing shared wireless resources for use by a different BSS. In various embodiments of the wireless device 102, the Dual BSS Response Message is non-preemptive, indicating that the dual BSS scheduler 202 need not immediately act on the message when the message is received.

The Dual BSS Command Message is issued by the dual BSS scheduler 202 to require the receiving MAC 204, 206 to immediately change states. In some embodiments, the Dual BSS Command Message specifies the state to which the MAC 204, 206 should transition. In other embodiments, the Dual BSS Command Message specifies that the receiving MAC 204, 206 should immediately transition from its current state to another known state. For example, a receiving MAC 204, 206 in active BSS state should transition to inactive BSS state, and a receiving MAC 204, 206 in inactive BSS state should transition to active BSS state. In various embodiments of the wireless device 102, the Dual BSS Command Message is preemptive, indicating that the receiving MAC 204, 206 should immediately act on the message and change BSS states when the message is received.

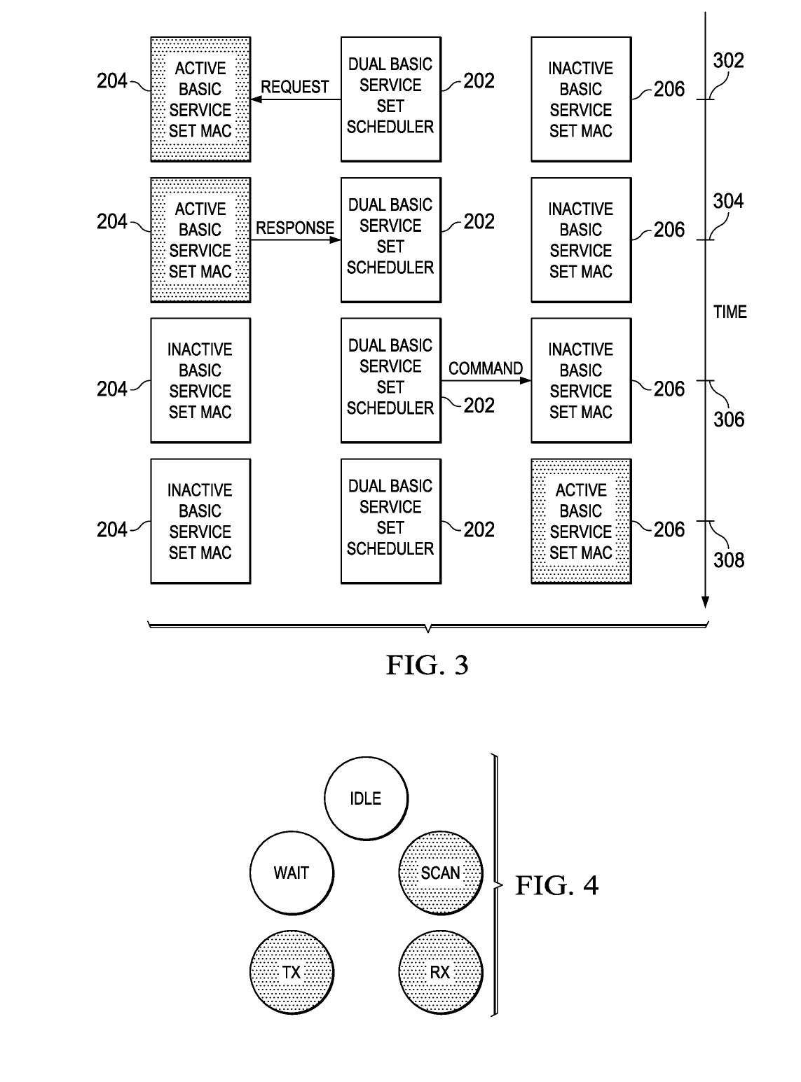

FIG. 3 shows exemplary message flow between the dual BSS scheduler 202 and the MACs 204, 206 in the dual BSS wireless device 102 in accordance with various embodiments. At time 302, MAC 204 is in active BSS state and the MAC 206 is in inactive BSS state. The dual BSS scheduler 202 issues a Dual BSS Request Message to the MAC 204 requesting that the MAC 204 relinquish access to the shared wireless resources and transition from the active BSS state to the inactive BSS state.

At time 304, the MAC 204 provides a Dual BSS Response Message to the dual BSS scheduler 202. The Response Message indicates that the MAC 204 is transitioning from active BSS state to inactive BSS state as requested.

At time 306, the MAC 204 has transitioned from active BSS state to inactive BSS state. The dual BSS scheduler 202, having received the Response Message at time 304, issues a Dual BSS Command Message to the MAC 206 requiring that the MAC 206 immediately transition from the inactive BSS state to the active BSS state. Accordingly, at time 308, the MAC 206 is in the active BSS state, and may access the shared wireless resources.

As shown in FIG. 3, an interval of time separates issuance of the Dual BSS Response Message from issuance of the Dual BSS Request Message. Embodiments of the dual BSS wireless device 102 minimize the interval of time between the messages and optimize use of shared resources and overall network utilization by monitoring the state of the MAC in the active BSS state in conjunction with BSS state changes.

FIG. 4 shows an exemplary view of activity states of the MAC 204, 206 in the dual BSS wireless device 102 in accordance with various embodiments. The possible activity states of the IEEE 802.11 MAC 204, 206 include idle, wait, transmit, receive, and scan. In the idle state, no data is available for transmission by the MAC 204, 206, and the MAC 204, 206 is awaiting a frame from a higher protocol level.

In the wait state, the MAC 204, 206 is executing a delay prior to execution of an operation scheduled to be performed when the delay expires. For Example, other devices may be communicating via the wireless medium, and the MAC 204, 206 waits a predetermined time for the medium to become idle. In another example, the MAC 204, 206 may delay for a preset time prior to initiating a data transmission or prior to initiating an acknowledgement or response frame for a received packet.

In the transmit state, the MAC 204, 206 uses the medium and other shared resources to transmit a frame. In the receive state, the MAC 204, 206 uses the medium to receive a frame, or is waiting to receive a frame.

In the scan state, the dual BSS wireless device 102 has lost its connection to the wireless network and is searching for a relevant frequency at which to re-establish a connection to the network.

Embodiments of the MACs 204, 206 monitor their internal activity state 210, and reply to the Dual BSS Request Message in accordance with the activity state of the MAC 204, 206 when the Request Message is received. If the MAC 204, 206 is in the active BSS state, and in the idle or wait state when a Dual BSS Request Message is received, then the MAC 204, 206 is not actively using or scheduled to use the shared wireless resources in the near term, and the MAC 204, 206 transitions from the active BSS state to the inactive BSS state immediately after the Dual BSS Request Message is received. The MAC 204, 206 provides the Dual BSS Response Message to the dual BSS scheduler 202 concomitant with the transition from active BSS state to inactive BSS state.

Conversely, if the MAC 204, 206 is in the active BSS state, and in the transmit, receive, or scan state when the Dual BSS Request Message is received, then the MAC 204, 206 is actively using or scheduled to use the shared wireless resources in the near term, and the MAC 204, 206 transitions from the active BSS state to the inactive BSS state after the current operation is complete. The MAC 204, 206 provides the Dual BSS Response Message to the dual BSS scheduler 202 concomitant with the transition from active BSS state to inactive BSS state. Thus, embodiments allow on-going transmissions and receptions to complete prior to relinquishing the shared wireless resources. This may be especially important for quality of service flows, where reducing the packet delay may be critical. Additionally, embodiments reduce the number of retransmissions required when alternating between BSSs by allowing ongoing transmissions and receptions to complete prior to changing BSS state.

Thus, embodiments of the MACs 204, 206 transition from active BSS state to inactive BSS state based on a received Dual BSS Request Message and the MAC state when the Dual BSS Request Message is received. Such embodiments improve network utilization by reducing retransmissions and improve quality of service by reducing packet delay.

Dual BSS wireless devices not basing activity state transitions on MAC state (i.e., embodiments not in accordance with the methods and systems of the present disclosure) may either immediately send a Dual BSS Response Message and enter an inactive state or wait an arbitrary amount of time before sending a Dual BSS Response Message and entering an inactive state. Both options are problematic. If an inactive BSS state is entered during a transmit, receive, or scan MAC activity state, a packet may be lost and/or retransmission may be required that cannot be performed until the BSS is once again activated. On the other hand, arbitrarily delaying the transition to inactive state may unnecessarily increase the amount of time that an inactive BSS waiting to become active remains in the inactive BSS state.

Various components of the wireless device 102, including at least some portions of the dual BSS scheduler 202, and/or the MACs 204, 206 can be implemented using a processor executing software programming that causes the processor to perform the operations described herein. In some embodiments, a processor executing software programming can schedule BSS service time, issue request and/or command messages, provide a response based on MAC state to a request to relinquish access to shared wireless resources, etc. Suitable processors include, for example, general-purpose microprocessors, digital signal processors, and microcontrollers. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems. Software programming that causes a processor to perform the operations disclosed herein can be stored in a computer readable storage medium. A computer readable storage medium comprises volatile storage such as random access memory, non-volatile storage (e.g., a hard drive, an optical storage device (e.g., CD or DVD), FLASH storage, or combinations thereof.

Some embodiments can implement portions of the wireless device 102, including portions of the dual BSS scheduler 202 and/or the MACs 204, 206 using dedicated circuitry (e.g., dedicated circuitry implemented in an integrated circuit). Some embodiments may use a combination of dedicated circuitry and a processor executing suitable software. For example, each MAC 204, 206 may be implemented using a distinct or separate processor or hardware circuitry, or using a shared processor or hardware circuitry. Selection of a hardware or processor/software implementation of embodiments is a design choice based on a variety of factors, such as cost, time to implement, and the ability to incorporate changed or additional functionality in the future.

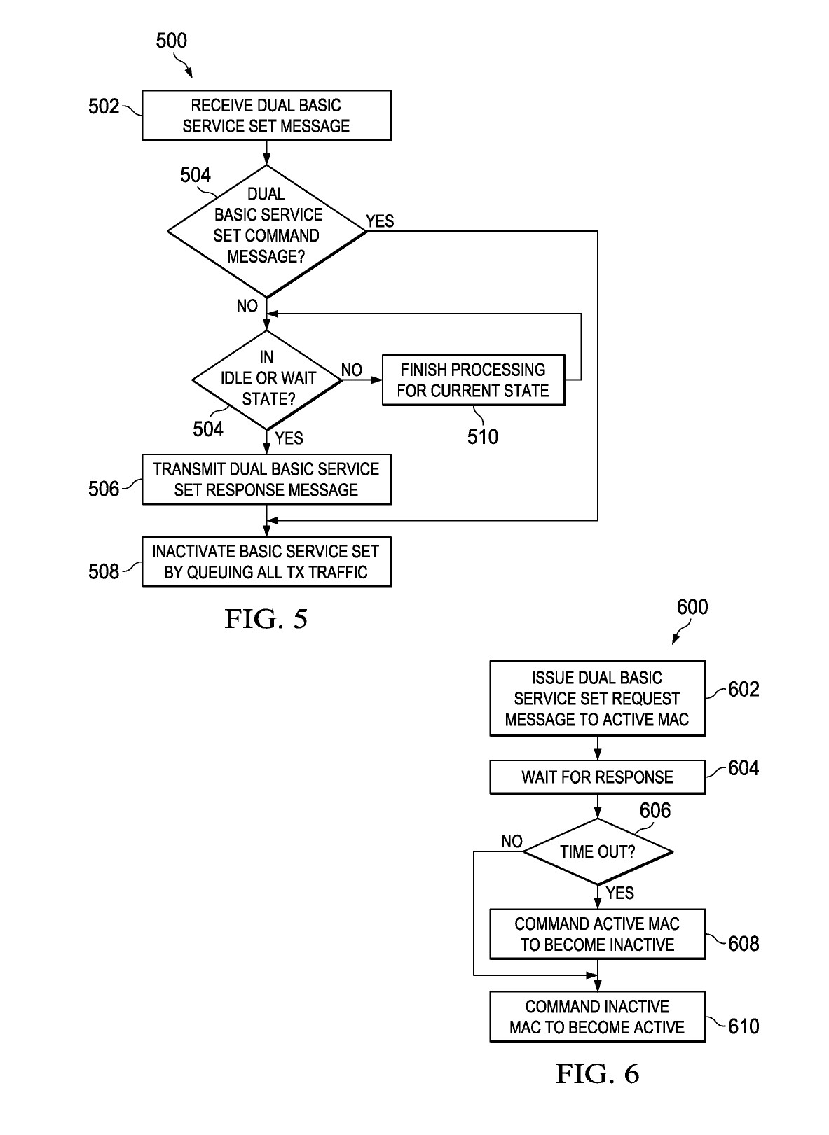

FIG. 5 shows a flow diagram for a method 500 for responding to a Dual BSS Request Message based on MAC state in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 500, as well as other operations described herein, can be implemented by a processor executing instructions stored in a computer readable medium.

In block 502, the BSS 1 MAC 204 is in the active BSS state, and receives a Dual BSS Message. The received Dual BSS message may be Dual BSS Command Message or a Dual BSS Request Message. The Dual BSS Request Message instructs the MAC 204 to transition from active BSS state to inactive BSS state with timing based on MAC state. The Dual BSS Command Message instructs the MAC 204 to immediately transition from active BSS state to inactive BSS state regardless of MAC state. Both messages cause the MAC 204 to relinquish control of the shared wireless resources, allowing the MAC 206 to access the shared wireless resources.

In block 504, the MAC 204 determines whether the received Dual BSS message is a Dual BSS Command Message. If the received Dual BSS message is a Dual BSS Command Message, then the MAC 204 immediately transitions from active BSS state to inactive BSS state in block 510, storing all outgoing data for transmission when the MAC 204 is reactivated.

If, in block 504, the MAC 204 determines that the received Dual BSS message is not a Dual BSS Command Message, but rather is a Dual BSS Request Message, then the MAC 204 checks its current state in block 506. If the MAC 204 is in idle or wait state, then the MAC 204 may immediately transition from active BSS state to inactive BSS state. Consequently, if the MAC 204 is in idle or wait state, then the MAC 204 transmits a Dual BSS Response Message in block 508, and transitions from active BSS state to inactive BSS state in block 510, storing all outgoing data for transmission when the MAC 204 is reactivated.

If in block 504 the MAC 204 is not in idle or wait state, then in block 512 the MAC 204 completes processing for its current state. For example, an ongoing transmission or reception is completed if the MAC 204 is in transmit or receive state when a Dual BSS Request Message is received. When processing for the current state is completed, in block 512, the MAC again checks for idle or wait state in block 506, and transitions to inactive BSS state in blocks 508-510, as described above, when idle or wait state is detected.

FIG. 6 shows a flow diagram for a method for changing BSS activation states in a dual BSS wireless 102 device in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 600, as well as other operations described herein, can be implemented by a processor executing instructions stored in a computer readable medium.

In block 602, the MAC 204 is in active BSS state and the MAC 206 is in inactive BSS state. The dual BSS scheduler 202 determines that the activity states of the MACs 204, 206 should be changed, allowing the MAC 206 to become active and access the shared wireless resources. To initiate the state transition, the dual BSS scheduler 202 issues a Dual BSS Request Message to the MAC 204.

In block 604, the dual BSS scheduler 202 waits for a Dual BSS Response Message to be received from the MAC 204. The dual BSS scheduler 202, measures the time from issuance of the Dual BSS Request Message. If, in block 606, the time from issuance of the Dual BSS Request Message exceeds a predetermined maximum wait time without the dual BSS scheduler 202 having received a Dual BSS Response Message from the MAC 204, then the dual BSS scheduler 202 issues a Dual BSS Command Message to the MAC 204 in block 608. The Dual BSS Command Message requires the MAC 204 to immediately transition to the inactive BSS state.

In block 610, the dual BSS scheduler 202 issues a Dual BSS Command Message to the MAC 206. The Dual BSS Command Message issued to the MAC 206 instructs the MAC 206 to immediately transition from the inactive BSS state to the active BSS state.

If, in blocks 604-606, the dual BSS scheduler 202 receives a Dual BSS Response Message from the MAC 204 prior to the expiration of the predetermined maximum wait time, then the dual BSS scheduler 202 issues a Dual BSS Command Message to the MAC 206 in block 610. The Dual BSS Command Message issued to the MAC 206 instructs the MAC 206 to immediately transition from the inactive BSS state to the active BSS state.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A wireless device, comprising:
a first medium access controller (MAC) configured to communicate in a first basic service set (BSS) via a first wireless network;
a second MAC configured to communicate in a second BSS via a second wireless network;
a BSS scheduler configured to time multiplex medium access by the first and second MACs;
wherein each of the first and second MACs is configured to provide a response to the BSS scheduler and to relinquish medium access when a request to relinquish medium access is received by the MAC, the timing of the response and relinquishment based on an activity state of the MAC when the request is received.

2. The wireless device of claim 1, wherein each MAC is configured to provide the response to the request immediately after reception of the request based on the MAC being in an idle state when the request is received.

3. The wireless device of claim 1, wherein each MAC is configured to provide the response to the request immediately after reception of the request based on the MAC being in a wait state when the request is received.

4. The wireless device of claim 1, wherein each MAC is configured to delay the response to the request until the MAC transitions out of a current state based on the MAC being in a transmit state when the request is received.

5. The wireless device of claim 1, wherein each MAC is configured to delay the response to the request until the MAC transitions out of a current state based on the MAC being in a receive state when the request is received.

6. The wireless device of claim 1, wherein each MAC is configured to delay the response until the MAC transitions out of a current state to the request based on the MAC being in a scan state when the request is received.

7. The wireless device of claim 1, wherein each MAC is configured to transition from an inactive BSS state to an active BSS state immediately when a BSS state change command is received by the MAC.

8. The wireless device of claim 1, wherein each MAC is configured to transition from an active BSS state to an inactive BSS state immediately when a BSS state change command is received by the MAC.

9. The wireless device of claim 1, wherein the BSS scheduler is configured to issue a BSS state change command to the second MAC based on receiving a response to the request provided by the first MAC.

10. The wireless device of claim 1, wherein the BSS scheduler is configured to issue a BSS state change command to the first MAC based on the first MAC not responding to the request within a predetermined time after the BSS scheduler issued the request.

11. The wireless device of claim 1, wherein at the first wireless network is peer-to-peer network and the second wireless network is one of an infrastructure network and a peer-to-peer network.

12. The wireless device of claim 1, further comprising medium access controller circuitry shared by the first and second MACs.

13. A method for dual basic service set control in a wireless device, comprising:
issuing to an active medium access controller (MAC) of the wireless device, by a BSS scheduler of the wireless device, a request for the active MAC to relinquish medium access;
providing, by the active MAC to the BSS scheduler, a response to the request, the timing of the response based on an activity state of the active MAC when the request is received; and
relinquishing medium access, by the active MAC, in conjunction with the providing.

14. The method of claim 13, wherein the providing comprises issuing the response immediately after reception of the request based on the MAC being in one of a wait state and an idle state when the request is received.

15. The method of claim 13, wherein the providing comprises delaying issue of the response until the MAC transitions out of a current state based on the MAC being in one of a transmit state, a receive state, and a scan state when the request is received.

16. The method of claim 13, further comprising issuing a BSS state change command to the active MAC causing the active MAC to transition to an inactive BSS state immediately on reception of the command.

17. The method of claim 16, wherein the issuing the BSS state change command is responsive to the active MAC failing to provide the response within a predetermined interval after the BSS scheduler issues the request.

18. The method of claim 13, further comprising issuing a BSS state change command to an inactive MAC causing the inactive MAC to transition to an active BSS state immediately on reception of the command.

19. The method of claim 18, wherein the issuing the BSS state change command is responsive to the active MAC providing the response within a predetermined interval after the BSS scheduler issues the request.

20. A medium access controller (MAC), comprising:
a MAC activity state indicator indicating an activity state of the MAC;
a dual basic service set (BSS) scheduler interface configured to:
receive a request from a BSS scheduler indicating that the MAC is to transition from an active BSS state to an inactive BSS state;
provide a response to the request to the dual BSS scheduler, the timing of the response based on the activity state of the MAC when the request is received; and
transition the MAC from the active BSS state to the inactive BSS state in conjunction with provision of the response.

21. The medium access controller of claim 20, wherein the dual BSS interface is configured to provide the response immediately after reception of the request based on the MAC activity state being one of a wait state and an idle state when the request is received.

22. The medium access controller of claim 20, wherein the dual BSS interface is configured to delay provision of the response until the MAC transitions out of a current state based on the current state being one of a transmit state, a receive state, and a scan state when the request is received.

23. The medium access controller of claim 20, wherein the dual BSS interface is configured to transition the MAC between the active BSS state and the inactive BSS state immediately on reception of a BSS state change command.

24. The medium access controller of claim 20, wherein the MAC is configured to time multiplex between a first peer-to-peer network and an one of an infrastructure network and a second peer-to-peer network.
